(19) United States
(12) Patent Application Publication
(10) Pub. No.: US 2013/0063775 A1
(43) Pub. Date: Mar. 14, 2013

(54) IMAGE FORMING APPARATUS CAPABLE OF PROVIDING ACTUAL-SIZE PREVIEW, METHOD OF CONTROLLING THE SAME, AND STORAGE MEDIUM

(71) Applicant: Morikazu ITO, Tokyo (JP)

(72) Inventor: Morikazu ITO, Tokyo (JP)

(73) Assignee: CANON KABUSHIKI KAISHA, Tokyo (JP)

(21) Appl. No.: 13/603,481

(22) Filed: Sep. 5, 2012

(30) Foreign Application Priority Data
Sep. 8, 2011 (JP) 2011-196150

(51) Int. Cl. G06K 15/02

(52) U.S. Cl. 358/1.15

(57) ABSTRACT

An image forming apparatus which enables a user to set the size of a sheet and/or configure an aggregation setting while checking the size of an image to be obtained when the image is actually printed on the sheet. The image forming apparatus sets the size of a sheet for image formation, and further sets aggregation printing. When setting the size of the sheet, an image is displayed for actual-size preview, in association with each of sizes of the sheet which can be set for image formation. When the aggregation printing is to be set, an image is displayed in the same size as a size of the image assumed when formed on the recording medium, in association with each of numbers of pages which can be set for the aggregation printing.

### BACKGROUND OF THE INVENTION

1. Field of the Invention

The present invention relates to an image forming apparatus, a method of controlling the same, and a storage medium, and more particularly to an image forming apparatus which is capable of providing an actual-size preview which displays an image in the same size as when the image is formed on a recording medium, a method of controlling the image forming apparatus, and a storage medium.

2. Description of the Related Art

Recently, with improvement of the performance of a display device provided e.g. in a console section, an image forming apparatus comes to be equipped with a function for previewing data accumulated in a hard disk thereof or data obtained by scanning a sheet original. For such a preview function, there has been proposed a technique for displaying characters and graphics included in an image to be printed in the same size as when the image is printed on a sheet, so as to enable the user to check the image size before printing. This preview will be hereinafter referred to as “actual-size preview”.

Further, the image forming apparatus is capable of setting aggregation printing in which a plurality of pages are collectively printed by combining the pages into a single page, so as to save sheets and toner.

When aggregation printing is executed, the size of printed characters and graphics is reduced from the size thereof on an original. Therefore, there is a demand for being able to get an actual-size preview so as to check the size of characters and drawings to be subjected to aggregation printing.

As a conventional technique for the actual-size preview in the above-mentioned aggregation printing, there has been proposed a technique of configuring an aggregation setting while checking characters reduced in size for aggregation printing in an actual-size preview (see e.g. Japanese Patent Laid-Open Publication No. 2010-272049).

The above-mentioned conventional technique makes it possible to configure the aggregation setting while checking size-reduced characters in an actual-size preview, but the preview can only be provided assuming that printing is performed on a sheet of a preset size.

Therefore, the conventional technique suffers from a problem that a user cannot set a sheet size while viewing an actual-size preview image on which an aggregation setting is reflected.

### SUMMARY OF THE INVENTION

The present invention provides an image forming apparatus which enables a user to set the size of a recording medium (sheet) and/or configure an aggregation setting while checking the size of an image to be obtained when the image is actually printed on the sheet, a method of controlling the image forming apparatus, and a storage medium.

In a first aspect of the present invention, there is provided an image forming apparatus comprising a forming unit configured to form an image on a recording medium, a display unit configured to display information, a first setting unit configured to set a size of a recording medium on which an image is to be formed, a second setting unit configured to set aggregation printing in which images of a plurality of pages are printed in an aggregated manner such that the images are formed on one page of the recording medium, a first actual-size preview unit configured to be operable when the size of the recording medium is to be set by the first setting unit, to cause the display unit to display an image in the same size as a size of the image assumed when formed on the recording medium, in association with each of sizes of the recording medium which can be set for image formation by the image forming apparatus, and a second actual-size preview unit configured to be operable when the aggregation printing is to be set by the second setting unit, to cause the display unit to display an image in the same size as a size of the image assumed when formed on the recording medium, in association with each of numbers of pages which can be set for the aggregation printing by the image forming apparatus.

In a second aspect of the present invention, there is provided an image forming apparatus comprising a forming unit configured to form an image on a recording medium, a display unit configured to display information, a first setting unit configured to set a size of a recording medium on which an image is to be formed, and an actual-size preview unit configured to be operable when the size of the recording medium is to be set by the first setting unit, to cause the display unit to display an image in the same size as a size of the image assumed when formed on the recording medium, in association with each of sizes of the recording medium which can be set for image formation by the image forming apparatus.

In a third aspect of the present invention, there is provided a controller comprising a print control unit configured to cause an image to be printed on a sheet, a display unit configured to display information, a first setting unit configured to set a sheet size of a sheet to be used for printing, a second setting unit configured to set aggregation printing in which images of a plurality of pages are printed in an aggregated manner such that the images are printed on one page of the sheet, a first actual-size preview unit configured to be operable when the size of the sheet is to be set by the first setting unit, to cause the display unit to display an image in the same size as a size of the image assumed when printed on the sheet, in association with each of sizes of the sheet which can be used in an image forming apparatus, and a second actual-size preview unit configured to be operable when the aggregation printing is to be set by the second setting unit, to cause the display unit to display an image in the same size as a size of the image assumed when printed on the sheet, in association with each of numbers of pages which can be set for the aggregation printing by the image forming apparatus.

In a fourth aspect of the present invention, there is provided a controller comprising a print control unit configured to cause an image to be printed on a sheet, a display unit configured to display information, a first setting unit configured to set a sheet size of a sheet to be used for printing, and an actual-size preview unit configured to be operable when a sheet size is to be set by the first setting unit, to cause the display unit to display an image in the same size as a size of the image assumed when printed on the sheet, in association with each of sizes of the sheet which can be used in an image forming apparatus.

In a fifth aspect of the present invention, there is provided a method of controlling an image forming apparatus including a forming unit configured to form an image on a recording medium, and a display unit configured to display information, comprising setting a size of a recording medium on which an image is to be formed, setting aggregation printing in which images of a plurality of pages are printed in an aggregated manner such that the images are formed on one page of the recording medium, causing, when the size of the recording medium is to be set, the display unit to display an image in the same size as a size of the image assumed when formed on the recording medium, in association with each of sizes of the recording medium which can be set for image formation by the image forming apparatus, and causing, when the aggregation printing is to be set, the display unit to display an image in the same size as a size of the image assumed when formed on the recording medium, in association with each of numbers of pages which can be set for the aggregation printing by the image forming apparatus.

In a sixth aspect of the present invention, there is provided a method of controlling an image forming apparatus including a forming unit configured to form an image on a recording medium, and a display unit configured to display information, comprising setting a size of a recording medium on which an image is to be formed, and causing, when the size of the recording medium is to be set, the display unit to display an image in the same size as a size of the image assumed when formed on the recording medium, in association with each of sizes of the recording medium which can be set for image formation by the image forming apparatus.

In a seventh aspect of the present invention, there is provided a method of controlling a controller including a print control unit configured to cause an image to be printed on a sheet, and a display unit configured to display information, comprising setting a sheet size of a sheet to be used for printing, setting aggregation printing in which images of a plurality of pages are printed in an aggregated manner such that the images are printed on one page of the sheet, causing, when the size of the sheet is to be set, the display unit to display an image in the same size as a size of the image assumed when printed on the sheet, in association with each of sizes of the sheet which can be used in an image forming apparatus, and causing, when the aggregation printing is to be set, the display unit to display an image in the same size as a size of the image assumed when printed on the sheet, in association with each of numbers of pages which can be set for the aggregation printing by the image forming apparatus.

In an eighth aspect of the present invention, there is provided a method of controlling a controller including a print control unit configured to cause an image to be printed on a sheet, and a display unit configured to display information, comprising setting a sheet size of a sheet to be used for printing, and causing, when a sheet size is to be set, the display unit to display an image in the same size as a size of the image assumed when printed on the sheet, in association with each of sizes of the sheet which can be used in an image forming apparatus.

In a ninth aspect of the present invention, there is provided a non-transitory computer-readable storage medium storing a computer-executable program for causing a computer to execute a method of controlling an image forming apparatus including a forming unit configured to form an image on a recording medium, and a display unit configured to display information, wherein the method comprises setting a size of a recording medium on which an image is to be formed, setting aggregation printing in which images of a plurality of pages are printed in an aggregated manner such that the images are formed on one page of the recording medium, causing, when the size of the recording medium is to be set, the display unit to display an image in the same size as a size of the image assumed when formed on the recording medium, in association with each of sizes of the recording medium which can be set for image formation by the image forming apparatus, and causing, when the aggregation printing is to be set, the display unit to display an image in the same size as a size of the image assumed when formed on the recording medium, in association with each of numbers of pages which can be set for the aggregation printing by the image forming apparatus.

In a tenth aspect of the present invention, there is provided a non-transitory computer-readable storage medium storing a computer-executable program for causing a computer to execute a method of controlling an image forming apparatus including a forming unit configured to form an image on a recording medium, and a display unit configured to display information, wherein the method comprises setting a size of a recording medium on which an image is to be formed, and causing, when the size of the recording medium is to be set, the display unit to display an image in the same size as a size of the image assumed when formed on the recording medium, in association with each of sizes of the recording medium which can be set for image formation by the image forming apparatus.

In an eleventh aspect of the present invention, there is provided a non-transitory computer-readable storage medium storing a computer-executable program for causing a computer to execute a method of controlling a controller including a print control unit configured to cause an image to be printed on a sheet, and a display unit configured to display information, wherein the method comprises setting a sheet size of a sheet to be used for printing, setting aggregation printing in which images of a plurality of pages are printed in an aggregated manner such that the images are printed on one page of the sheet, causing, when the size of the sheet is to be set, the display unit to display an image in the same size as a size of the image assumed when printed on the sheet, in association with each of sizes of the sheet which can be used in an image forming apparatus, and causing, when the aggregation printing is to be set, the display unit to display an image in the same size as a size of the image assumed when printed on the sheet, in association with each of numbers of pages which can be set for the aggregation printing by the image forming apparatus.

In a twelfth aspect of the present invention, there is provided a non-transitory computer-readable storage medium storing a computer-executable program for causing a computer to execute a method of controlling a controller including a print control unit configured to cause an image to be printed on a sheet, and a display unit configured to display information, wherein the method comprises setting a sheet size of a sheet to be used for printing, and causing, when a sheet size is to be set, the display unit to display an image in the same size as a size of the image assumed when printed on the sheet, in association with each of sizes of the sheet which can be used in an image forming apparatus.

According to the present invention, it is possible to enable a user to set the size of a recording medium (sheet) and/or configure an aggregation setting while checking the size of an image to be obtained when the image is actually printed on the sheet.

Further features of the present invention will become apparent from the following description of exemplary embodiments with reference to the attached drawings.

### BRIEF DESCRIPTION OF THE DRAWINGS

FIG. 1 is a schematic block diagram of an image forming apparatus according to an embodiment of the present invention.

FIG. 2 is a block diagram of the software configuration of a control unit appearing in FIG. 1.

FIG. 3 is a diagram useful in explaining the outline of a process for displaying a preview image on a console section appearing in FIG. 1.

FIG. 4 is a flowchart of a print process executed by a CPU appearing in FIG. 1.

FIGS. 5A and 5B are a flowchart of an actual-size preview process executed by the CPU.

FIG. 6 is a diagram illustrating the transition of contents displayed for actual-size preview on the console section.

FIG. 7 is a flowchart of a magnification process executed by the CPU.

FIG. 8 is a flowchart of a print size check process executed by the CPU.

FIG. 9 is a flowchart of a poster print process executed by the CPU.

FIG. 10 is a flowchart of a preview display check process executed by the CPU.

FIG. 11 is a flowchart of an actual-size preview display portion designation process executed by the CPU.

### DESCRIPTION OF THE EMBODIMENTS

The present invention will now be described in detail below with reference to the accompanying drawings showing an embodiment thereof.

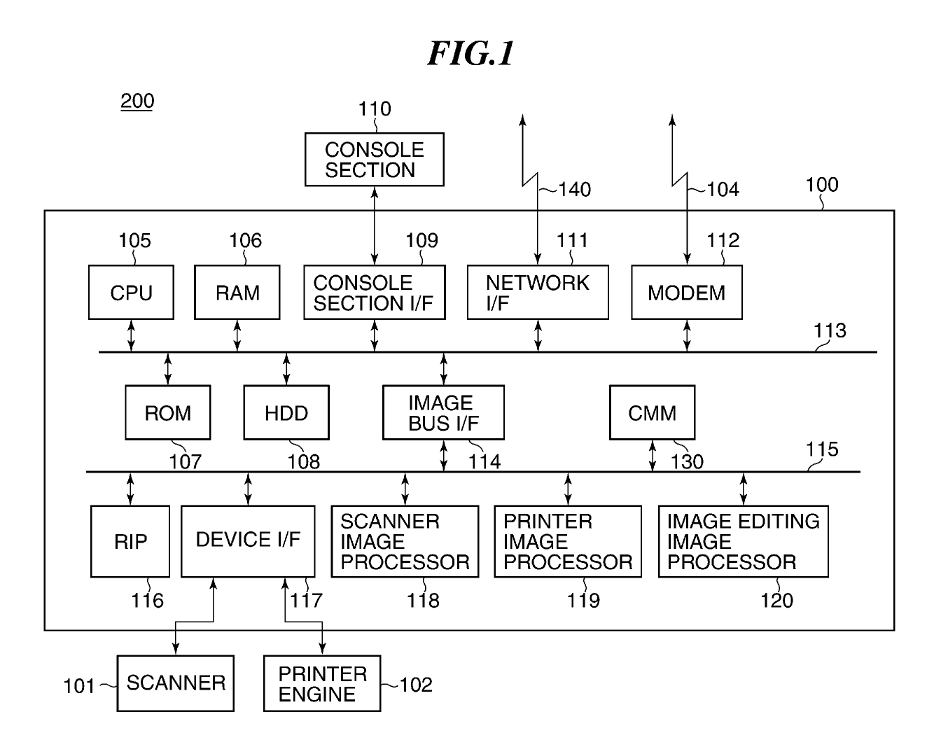

FIG. 1 is a schematic block diagram of an image forming apparatus (hereinafter referred to as “the MFP”) 200 according to the embodiment of the present invention.

Referring to FIG. 1, a control unit 100 is connected to a scanner 101 as an image input device and a printer engine 102 as an image output device so as to perform control for reading and printout of image data. Note that in the present embodiment, “forming an image on a recording medium” will also be expressed as “outputting an image”. Further, a sheet is used as a recording medium, but this is not limitative.

The control unit 100 is connected to a LAN 140 and a public communication line 104, and performs control for inputting and outputting image information and device information via the LAN 140.

The printer engine 102 is connected to the control unit 100 by a device interface 117 to perform processing for outputting drawing data generated by the control unit 100 onto a sheet. The scanner 101 is connected to the control unit 100 by the device interface 117 to read an original and output data indicative of the original to the control unit 100. The printer engine 102 corresponds to a forming unit configured to form an image on a sheet.

A CPU 105 is a central processing unit for controlling the MFP 200. A RAM 106 is a system work memory used for operation of the CPU 105. The RAM 106 also functions as an image memory for temporarily storing image data.

A ROM 107 is a boot ROM that stores a boot program for the system.

An HDD (hard disk drive) 108 stores system software used for various processing, input image data, and so forth.

A console section interface 109 provides interface with a console section 110 having a display screen on which image data and the like can be displayed, and outputs operation screen data to the console section 110.

Further, the console section interface 109 also outputs information input by a user via the console section 110 to the CPU 105.

The console section 110 not only receives an operation from the user, but also corresponds to a display unit configured to display information for the user e.g. on a touch-panel display. As one item of such information, there may mentioned a preview of an image. In the present embodiment, the MFP is configured to be capable of providing an actual-size preview.

The term “actual-size preview” is intended to mean a preview of a target image on the console section 110 or a PC monitor in the same size as that of the target image to be assumed when output to i.e. printed on a sheet.

In other words, assuming that a preview image displayed for actual-size preview and an image output on a sheet are placed one over the other, they will perfectly overlap each other to show that they are equal in size, i.e. have the same size. Therefore, execution of the actual-size preview enables the user to more easily picture an image of a print product to be output within his/her mind. Further, the MFP 200 according to the present embodiment is capable of configuring an aggregation setting for forming two or more images on a single sheet in an aggregate manner. Note that “the same size” in the actual-size preview image is not limited to exactly the same size with no error, but it includes substantially the same size with a slight error.

A network interface 111 is implemented e.g. by a LAN card. The network interface 111 is connected to the LAN 140 to input and output information from and to external apparatuses. A modem 112 is connected to the public communication line 104 to input and output information from and to external apparatuses. The above-mentioned units are electrically connected to each other by a system bus 113.

An image bus interface 114 is a bus bridge that connects the system bus 113 with an image bus 115 for use in high-speed transfer of image data, and performs conversion of data format.

Connected to the image bus 115 are a RIP (raster image processor) 116, the device interface 117, a scanner image processor 118, a printer image processor 119, an image editing image processor 120, and a CMM (color management module) 130.

The RIP 116 converts a PDL (page description language) code or vector data, described hereinafter, into an image.

The device interface 117 connects the control unit 100 to the scanner 101 and the printer engine 102 to perform synchronous-to-asynchronous or asynchronous-to-synchronous conversion of image data.

The scanner image processor 118 performs various kinds of processing, such as correction, manipulation, and editing, of image data input from the scanner 101.

The printer image processor 119 performs correction, resolution conversion, etc. of image data to be printed out, in accordance with the printer engine 102.

The image editing image processor 120 performs various kinds of image processing, such as rotation of image data and compression and expansion of image data.

The CMM 130 is a dedicated hardware module for performing color conversion (also referred to as “color space conversion”) on image data based on a profile or calibration data.

The profile is information including a function for converting color image data expressed by a color space dependent on an apparatus to a color space (e.g. Lab) independent of the apparatus. The calibration data is for correcting color reproduction characteristics of the scanner 101 and the printer engine 102.

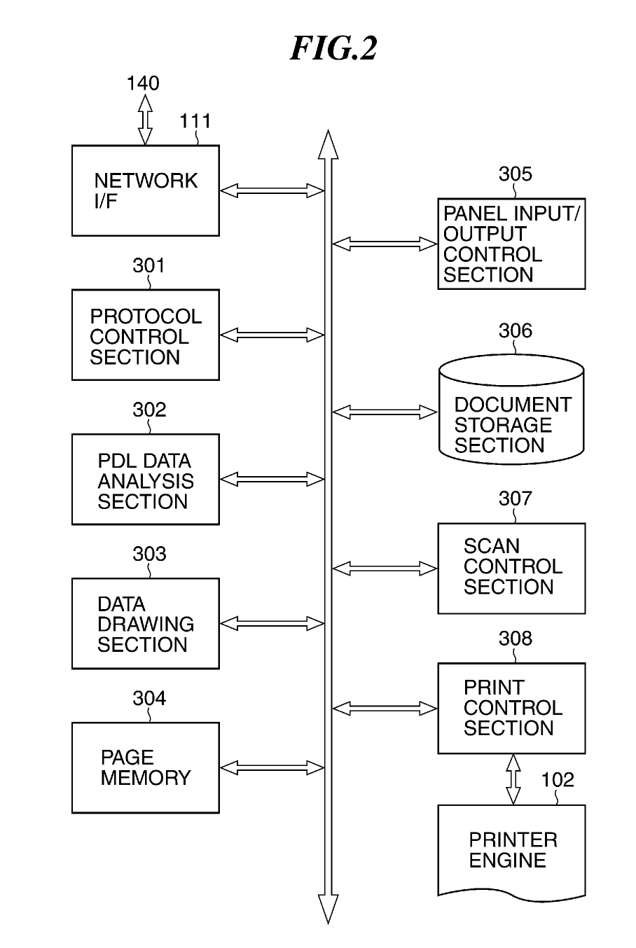

FIG. 2 is a block diagram of the software configuration of the control unit 100 appearing in FIG. 1.

From the following description with reference to FIG. 2, description of the network interface 111 and the printer engine 102 will be omitted.

A protocol control section 301 performs network protocol analysis and the like processing so as to communicate with an external apparatus. A PDL data analysis section 302 is a unit configured to analyze PDL data and convert the PDL data to a display list having a format that can be processed more easily. The display list generated by the PDL data analysis section 302 is passed to a data drawing section 303 and is processed.

The data drawing section 303 converts the display list to bitmap data, and the converted bitmap data is sequentially drawn in a page memory 304.

The page memory 304 is provided in the RAM 106 as an area for temporarily storing bitmap data rendered by a renderer. A panel input/output control section 305 controls input to and output from the console section 110.

A document storage section 306 stores a data file in the HDD 108. A scan control section 307 various kinds of processing, such as correction, manipulation, and editing, of image data input from the scanner 101.

A print control section 308 converts data stored in the page memory 304 to a video signal and transfers an image to the printer engine 102.

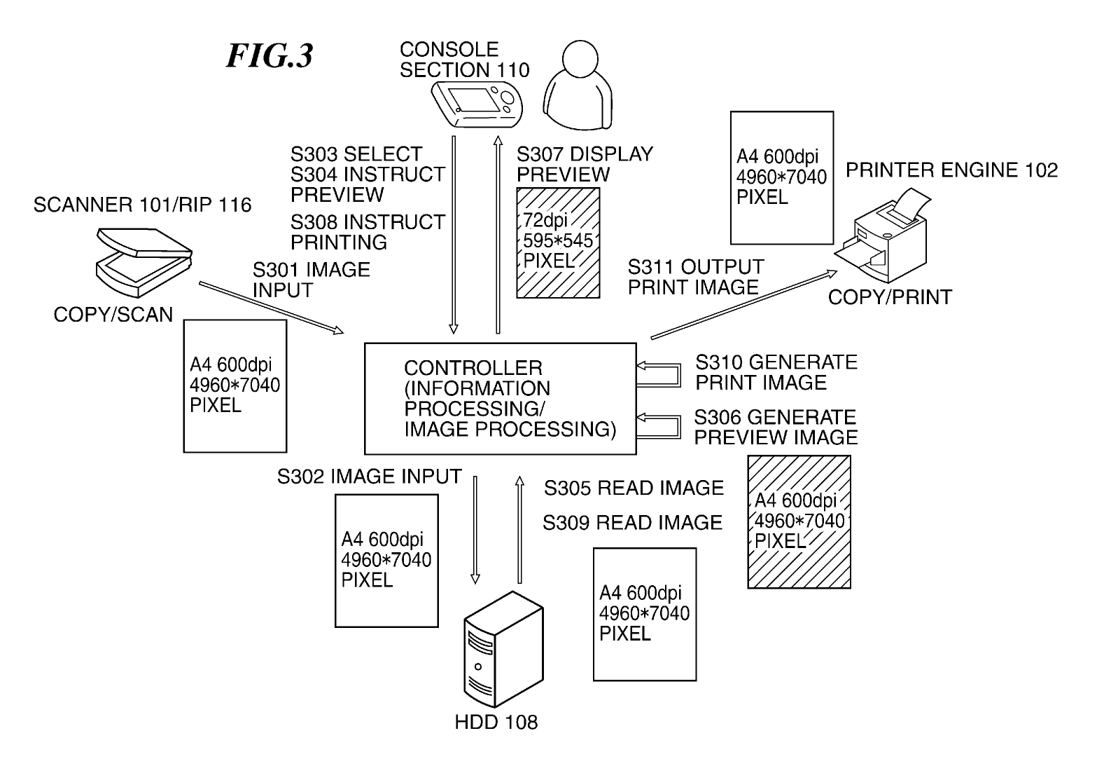

FIG. 3 is a diagram useful in explaining the outline of a process for displaying a preview image on the console section 110.

Referring to FIG. 3, image data is input from the scanner 101 or the RIP 116 (step S301) and is stored in the HDD 108 under the control of the control unit 100 (step S302).

In the console section 110, according to user's settings (step S303), data stored in the HDD 108 is selected, and a preview instruction is issued (step S304), whereby a preview image generated in response to the preview instruction is displayed (step S307).

Further, data stored in the HDD 108 is selected, and a print instruction is issued (step S308). The control unit 100 having received the preview instruction accesses the HDD 108. Then, the control unit 100 reads out the selected data (steps S305 and S309) and generates a preview image (step S306) or a print image (step S310).

When the generated image is the preview image, it is output to the console section 110, while when the same is the print image, it is output to the printer engine 102 (step S311).

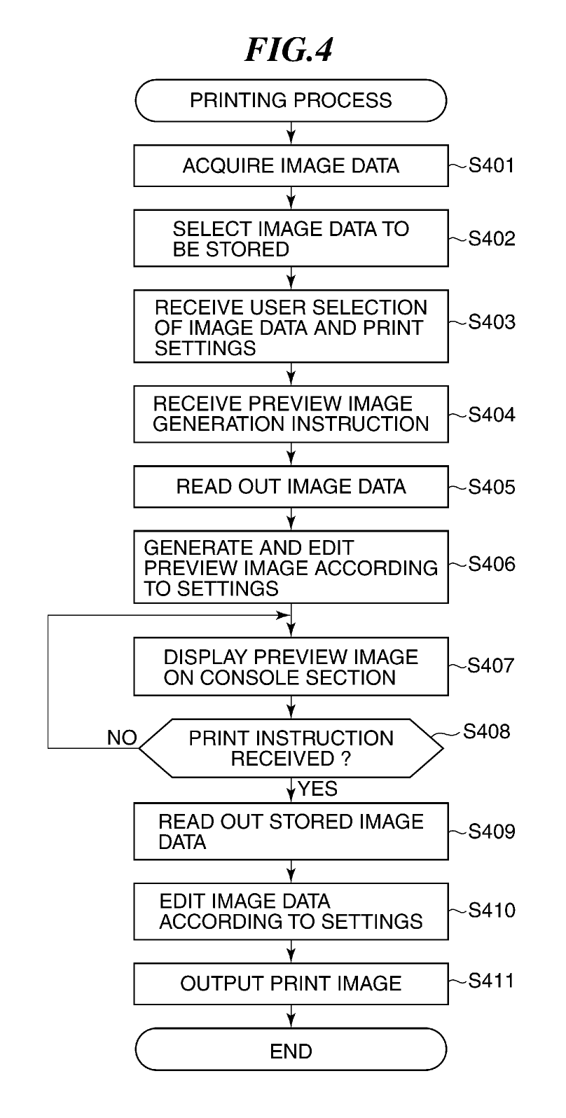

FIG. 4 is a flowchart of a print process executed by the CPU 105 appearing in FIG. 1.

Referring to FIG. 4, first, the CPU 105 acquires image data (step S401). The acquired image data includes image data scanned from a sheet original, rasterized image data obtained by rendering PDL data, and data received by FAX.

Then, the CPU 105 selects image data to be stored in the HDD 108 from the acquired data (step S402). The processing is repeatedly carried out until storage of image data in the HDD 108 is completed.

Then, the CPU 105 receives selection of image data to be printed and print settings from the user via the console section 110 (step S403). Further, the CPU 105 receives a preview image generation instruction from the user (step S404).

Thereafter, the CPU 105 reads out image data designated by the preview image generation instruction from the HDD 108 (step S405), and generates and edits a preview image according to settings (step S406). Then, the generated preview image is displayed on the console section 110 (step S407).

Then, the CPU 105 determines whether or not a print instruction has been received from the user (step S408). If it is determined in the step S408 that a print instruction has not been issued (NO to the step S408), the CPU 105 returns to the step S407, wherein the CPU 105 waits until a print instruction is issued.

On the other hand, if a print instruction has been issued (YES to the step S408), the CPU 105 reads out image data designated for printing from the HDD 108 (step S409). Then, the CPU 105 edits the image data according to the print settings (step S410). Then, the CPU 105 outputs a print image obtained by editing the image data to the printer engine 102 (step S411), followed by terminating the present process.

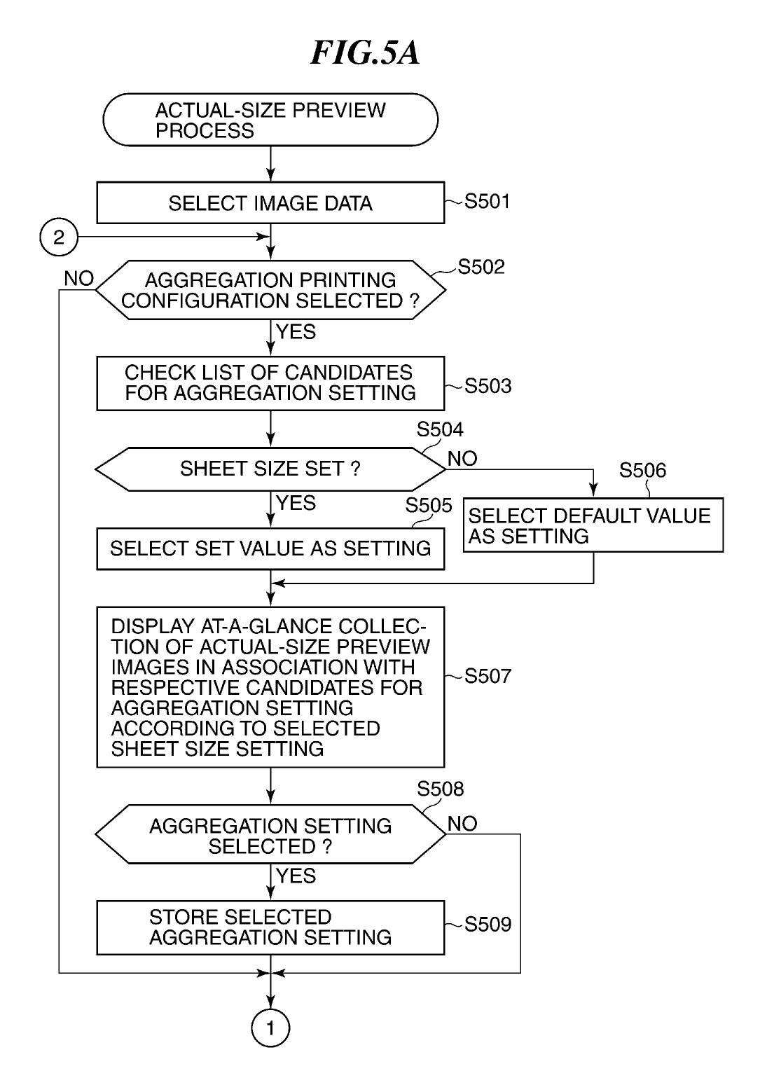

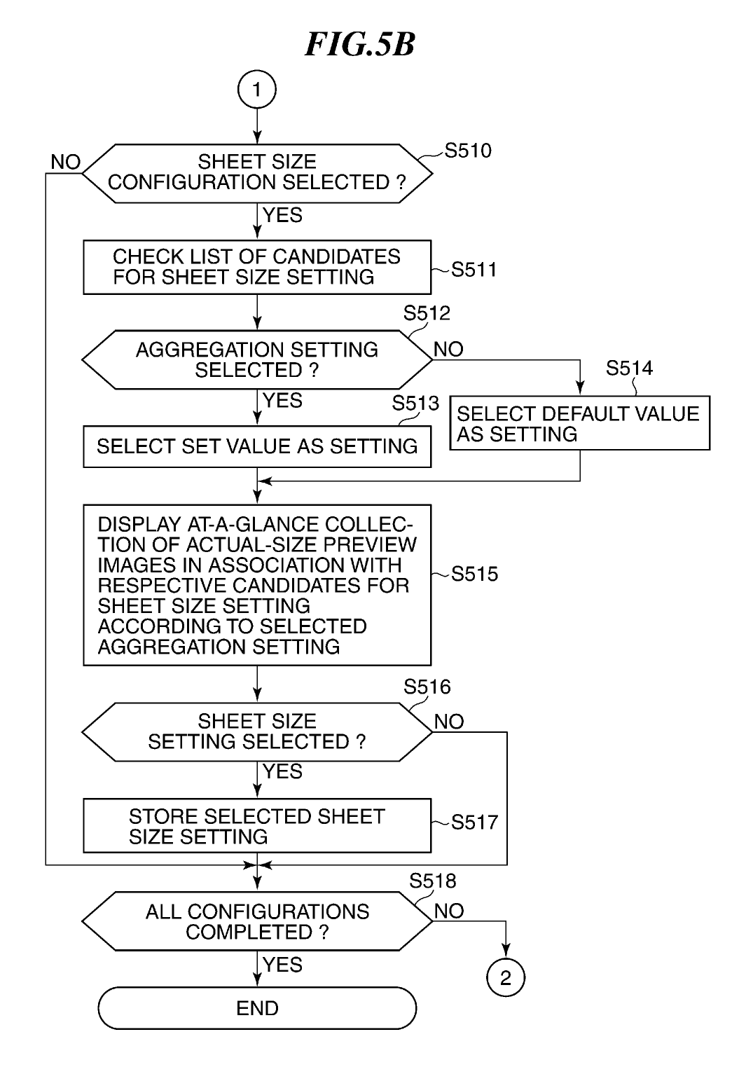

FIGS. 5A and 5B are a flowchart of an actual-size preview process executed by the CPU 105 appearing in FIG. 1.

First, the CPU 105 selects image data to be previewed, according to an operation performed by the user using the console section 110 (step S501). Then, the CPU 105 determines whether or not aggregation printing configuration has been selected by the user (step S502). If it is determined in the step S502 that aggregation printing configuration has not been selected (NO to the step S502), the CPU 105 proceeds to a step S510.

On the other hand, if it is determined that aggregation printing configuration has been selected (YES to the step S502), the CPU 105 checks a list of candidates each of which can be set as the aggregation setting (step S503). The aggregation setting is for laying out images of a plurality of pages (N pages) in one page in an aggregated manner, and is generally called “Nin1 layout setting”. The value of N in Nin1 layout is different depending on the apparatus, and is set e.g. to 2, 4, 6, 8, 9, . . . . In the step S503, the CPU 105 checks aggregation settings (values of N in Nin1) according to which the self apparatus (MFP 200) can execute aggregation printing, and identifies these values as the candidates to be entered in the list.

Then, the CPU 105 determines whether or not a sheet size has been set by the user (step S504). If it is determined in the step S504 that a sheet size has been set by the user (YES to the step S504), the CPU 105 selects the value of the set sheet size as a sheet size setting (step S505), and then proceeds to a step S507.

On the other hand, if a sheet size has not been set by the user (NO to the step S504), the CPU 105 selects the default value as the sheet size setting (step S506).

Then, according to the value of the sheet size selected in the step S505 or S506, the CPU 105 displays an at-a-glance collection of actual-size preview images in association with respective candidates each of which can be set as the aggregation setting, which are in the list checked in the step S503 (step S507). The CPU 105 determines whether or not an aggregation setting has been selected from the candidates displayed for actual-size preview (step S508). If it is determined in the step S508 that no aggregation setting has been selected (NO to the step S508), the CPU 105 proceeds to the step S510. The processing in the step S507 is an example of operation of a second actual-size preview unit configured to display an actual-size preview image on the console section 110 in association with each of numbers of pages which can be set for the aggregation printing (i.e. the value of N of Nin1) by the MFP 200, when the user sets the aggregation printing.

On the other hand, if it is determined in the step S508 that an aggregation setting has been selected (YES to the step S508), the selected aggregation setting is stored in the RAM 106 (step S509).

Then, the CPU 105 determines whether or not sheet size configuration has been selected by the user (step S510). If it is determined in the step S510 that sheet size configuration has not been selected (NO to the step S510), the CPU 105 proceeds to a step S518.

On the other hand, if sheet size configuration has been selected by the user (YES to the step S510), the CPU 10 checks a list of candidates each of which can be set as a sheet size setting for the MFP 200 (step S511). In this step, as the candidates, the sheet sizes of sheets currently existing in sheet feeders may be checked, or alternatively, sheet sizes compatible with the MFP 200 may be checked irrespective of whether sheets currently exist in the sheet feeders.

Then, the CPU 105 determines whether or not an aggregation setting has been set by the user (step S512). If it is determined in the step S512 that an aggregation setting has been set (YES to the step S512), the CPU 105 selects a set value for the aggregation setting (step S513), and then proceeds to a step S515.

On the other hand, if no aggregation setting has been configured (NO to the step S512), the CPU 105 selects a default value for the aggregation setting (step S514). The default value of the aggregation setting is generally set to linl (i.e. a value indicating that aggregation printing is not to be executed), and hence in the step S514, no execution of aggregation printing is specified as a setting of aggregation printing (aggregation setting).

Then, according to the aggregation setting selected in the step S513 or S514, the CPU 105 displays an at-a-glance collection of actual-size preview images in association with respective candidates each of which can be set as the sheet size setting, which are in the list checked in the step S511 (step S515). Then, the CPU 105 determines whether or not a sheet size setting has been selected by the user from the candidates displayed for actual-size preview (step S516). If it is determined in the step S516 that no sheet size setting has been selected (NO to the step S516), the CPU 105 proceeds to the step S518. The processing in the step S515 is an example of operation of a first actual-size preview unit configured to display an actual-size preview image on the console section 110 in association with each of sizes which can be set for image formation by the MFP 200, when the user sets a sheet size.

On the other hand, if it is determined in the step S516 that a sheet size setting has been selected (YES to the step S516), the selected sheet size setting is stored in the RAM 106 (step S517).

Then, the CPU 105 determines whether or not all required configurations have been completed (step S518). If all required configurations have been completed (YES to the step S518), the present process is terminated, whereas if all required configurations have not been completed (NO to the step S518), the CPU 105 returns to the step S502.

The description of the actual-size preview process in FIGS. 5A and 5B is given for explaining the relationship between aggregation setting and sheet size setting, by way of example. However, the actual-size preview process can be applied to any combination of settings including magnification setting and poster print setting, described hereinafter, which have an influence on the size of an image when the image is output onto a sheet. For example, the actual-size preview process can be applied to a combination of sheet size setting and poster print setting or a combination of aggregation setting and magnification setting.

According to the process in FIGS. 5A and 5B, when the user is to set a sheet size, an actual-size preview image is displayed in association with each sheet size which can be set for image formation by the MFP 200 (step S515). Further, when the user is to set aggregation printing, an actual-size preview image is displayed in association with each value indicative of the number of pages, which can be set as the aggregation setting for the MFP 200 (step S507). Consequently, the user can set a sheet size and configure aggregation printing while picturing an image of a sheet actually having an image or images formed thereon within his/her mind.

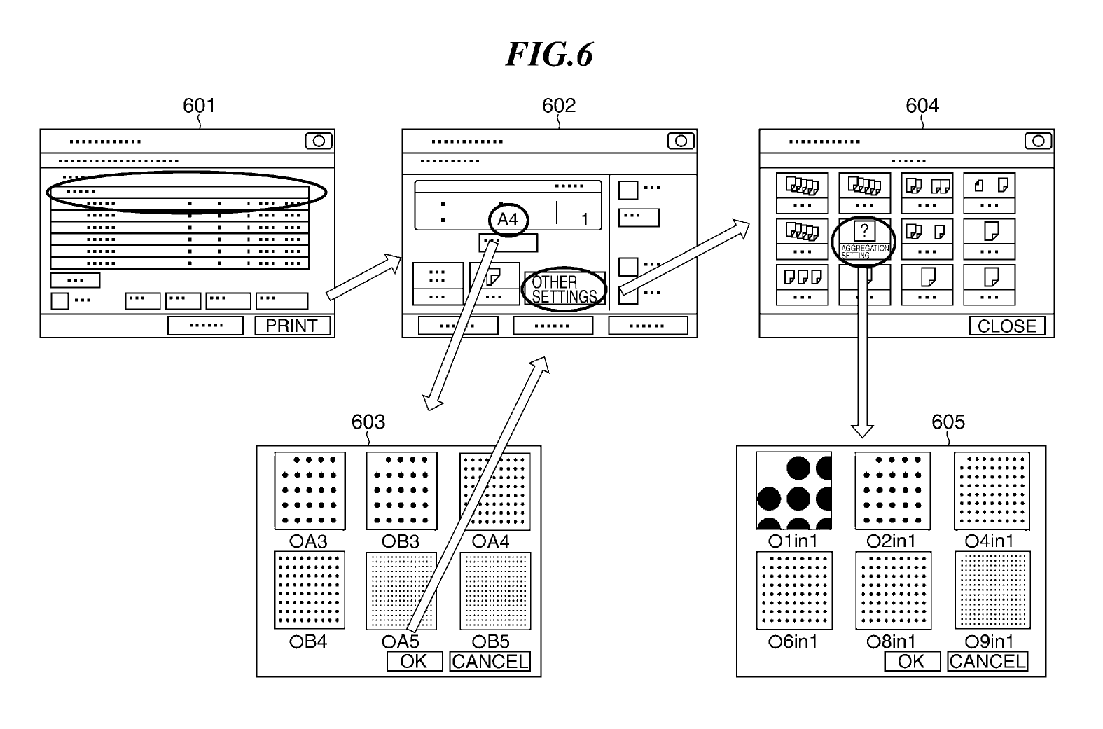

FIG. 6 is a diagram illustrating the transition of contents displayed for actual-size preview on the console section 110 appearing in FIG. 1.

Referring to FIG. 6, a screen 601 serves as a user interface for use in selecting data to be printed or previewed. On the screen 601 is displayed a list of image data items stored in the HDD 108. The display contents correspond to contents displayed in the step S501 in FIG. 5A. When an image data item stored in the HDD 108 is selected on the screen 601 and a “print” button is pressed, a sheet setting screen 602 is displayed.

When a button “A4” for setting a sheet size “A4” is pressed on the sheet setting screen 602, an actual-size preview screen 603 is displayed. The sheet setting screen 602 corresponds to contents displayed in the step S510 in FIG. 5B.

On the actual-size preview screen 603, actual-size preview images are displayed in an enumerated manner in association with the respective sheet sizes that can be set, so as to enable selective setting of a sheet size. The actual-size preview screen 603 corresponds to contents displayed in the step S515 in FIG. 5B.

When an A3 sheet size is selected, for example, on the actual-size preview screen 603 and an “OK” button is pressed, the screen returns to the sheet setting screen 602.

Then, when an “other settings” button is pressed on the sheet setting screen 602, a detailed setting screen 604 is displayed. When an “aggregation setting” button is pressed on the detailed setting screen 604, an aggregation setting screen 605 is displayed.

On the aggregation setting screen 605, actual-size preview images are displayed in an enumerated manner in association with respective aggregation settings that can be set, so as to enable selective setting of an aggregation setting. At this time, the sheet size is set to A3, and therefore the actual-size preview images are displayed according to the A3 sheet size. This corresponds to the processing carried out in the step S507 in FIG. 5A.

When an aggregation setting of 2 in 1 is selected, for example, on the aggregation setting screen 605 and an “OK” button is pressed, the detailed setting screen 604 is displayed. When a “close” button is pressed on the detailed setting screen 604, the sheet setting screen 602 is displayed again with its contents reflected by the aggregation setting of 2 in 1 selected on the aggregation setting screen 605.

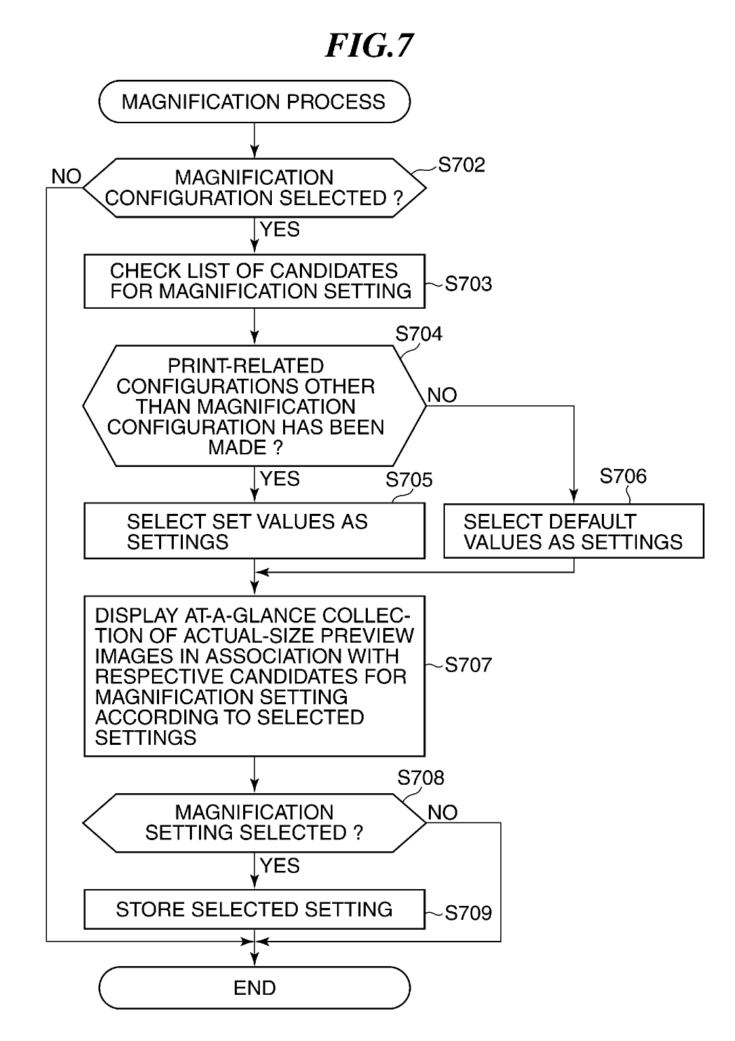

FIG. 7 is a flowchart of a magnification process executed by the CPU 105 appearing in FIG. 1.

The magnification process shown in FIG. 7 is one of processes for respective print-related configurations, such as the aggregation configuration and the sheet size configuration described with reference to FIGS. 5A and 5B. This magnification process can be inserted between the steps S501 and S502 in FIG. 5A, the steps S509 in FIG. 5A and S510 in FIG. 5B, or the steps S517 and S518 in FIG. 5B.

Referring to FIG. 7, the CPU 105 determines whether or not magnification configuration has been selected by the user (step S702). If it is determined in the step S702 that magnification configuration has not been selected (NO to the step S702), the present process is immediately terminated.

On the other hand, if magnification configuration has been selected (YES to the step S702), the CPU 105 checks a list of candidates each of which can be set as the magnification setting of the MFP 200 (step S703).

Then, the CPU 105 determines whether or not print-related configurations other than the magnification configuration have been made (step S704). If it is determined in the step S704 that print-related configurations other than the magnification configuration have been made (YES to the step S704), the CPU 105 selects values set in the configurations as respective settings (step S705), and then the CPU 105 proceeds to a step S707.

On the other hand, if no print-related configurations other than the magnification configuration have been made (NO to the step S704), the CPU 105 selects default values of the print-related configurations as respective settings (step S706).

Then, according to the setting selected in the step S705 or S706, the CPU 105 displays an at-a-glance collection of actual-size preview images in association with respective candidates each of which can be set as the magnification setting of the MFP 200, which are in the list checked in the step S703 (step S707). Then, the CPU 105 determines whether or not a magnification setting has been selected by the user from the candidates displayed for actual-size preview (step S708). If it is determined in the step S708 that no magnification setting has been selected (NO to the step S708), the present process is immediately terminated.

On the other hand, if a magnification setting has been selected (YES to the step S708), the CPU 105 stores the selected magnification setting in the RAM 106 (step S709), followed by terminating the present process.

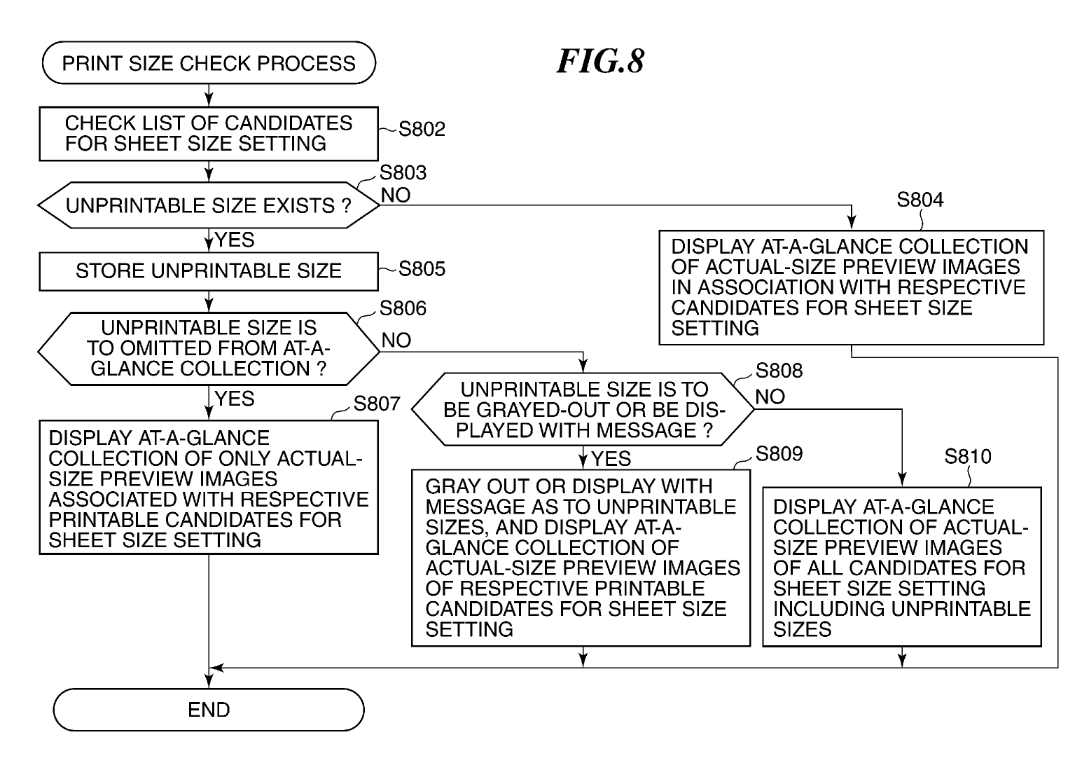

FIG. 8 is a flowchart of a print size check process executed by the CPU 105 appearing in FIG. 1.

The print size check process shown in FIG. 8 may be executed in the step S511 in FIG. 5B.

Referring to FIG. 8, the CPU 105 checks a list of candidates each of which can be set as the sheet size setting (step S802). Then, the CPU 105 determines whether or not there is an unprintable size (step S803). The term “unprintable size” is intended to mean a size of sheets that are originally printable by the MFP 200 but is currently unprintable e.g. due to running out of sheets, for example. In other words, a type of sheets having run out is a type of sheets on which image formation cannot be performed due to absence of sheets even though the MFP 200 is capable of forming an image thereon.

If it is determined in the step S803 that there is no unprintable size (NO to the step S803), the CPU 105 displays an at-a-glance collection of actual-size preview images in association with respective candidates each of which can be set as the sheet size setting (step S804), followed by terminating the present process.

On the other hand, if there is an unprintable size (YES to the step S803), the CPU 105 stores the unprintable size in the RAM 106 (step S805) and determines whether or not the MFP 200 is configured such that unprintable sizes are omitted from the at-a-glance collection (step S806).

If it is determined in the step S806 that the MFP 200 is configured such that unprintable sizes are omitted from the at-a-glance collection (YES to the step S806), the CPU 105 displays an at-a-glance collection of actual-size preview images in association with respective only printable ones of the candidates in the list each of which can be set as the print size setting (step S807), followed by terminating the present process.

On the other hand, if the MFP 200 is configured such that unprintable sizes are also displayed in the at-a-glance collection (NO to the step S806), the CPU 105 determines whether or not the MFP 200 is configured such that unprintable sizes are grayed out or displayed with a warning message (step S808).

If it is determined in the step S808 that the MFP 200 is configured such that unprintable sizes are grayed out or displayed with a warning message (YES to the step S808), the CPU 105 proceeds to a step S809. In the step S809, unprintable sizes are grayed out or displayed with a warning message. On the other hand, printable sizes are regarded as candidates each of which can be set as the sheet size setting, and an at-a-glance collection of actual-size preview images are displayed in association with the respective candidates (step S809), followed by terminating the present process.

On the other hand, if it is determined in the step S808 that the MFP 200 is not configured such that unprintable sizes are grayed out or displayed with a warning message (NO to the step S808), an at-a-glance collection of actual-size preview images are displayed in association with all the candidates including the unprintable sizes (step S810), respectively, followed by terminating the present process.

According to the process in FIG. 8, when there is a sheet size of a type of sheets on which image formation cannot be practically performed e.g. due to running out of sheets, one of the following processes can be executed: As a first process, information indicative of existence of the sheet size of a type of sheets on which image formation cannot be practically performed is displayed on the console section 110. As a second process, an image associated with the sheet size of a type of sheets on which image formation cannot be practically performed is grayed out in an actual-size preview image, or alternatively, display of the actual-size preview image associated with the sheet size of a type of sheets on which image formation cannot be practically performed is disabled.

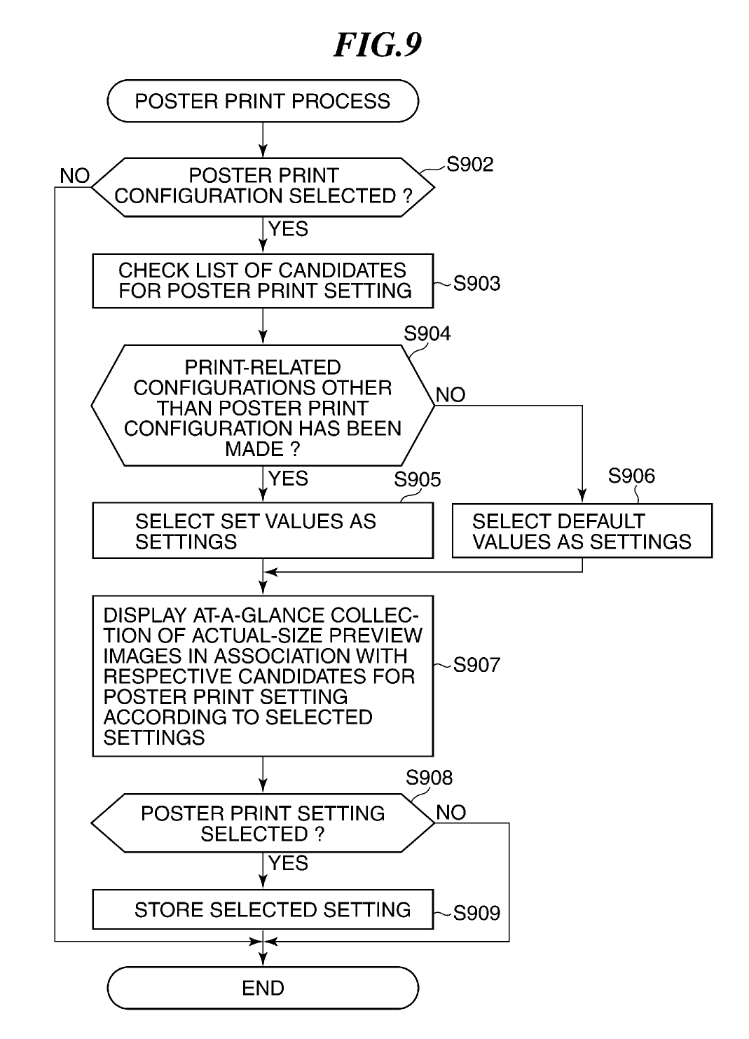

FIG. 9 is a flowchart of a poster print process executed by the CPU 105 appearing in FIG. 1. Poster printing refers to a process in which an image constituting one page is enlarged and divided into sections and the enlarged sections of the image are printed onto respective sheets of a printable size. The sheets having the sections of the image printed thereon are then pieced together to obtain a single large print result (poster).

The poster print process shown in FIG. 9 is one of the processes for respective print-related configurations, such as the aggregation configuration and the sheet size configuration described with reference to FIGS. 5A and 5B. Therefore, the present poster print process can be inserted between the steps S501 and S502 in FIG. 5A, the step S509 in FIG. 5A and the step S517 in FIG. 5B, or the steps S517 and S518 in FIG. 5B.

Referring to FIG. 9, the CPU 105 determines whether or not poster print configuration has been selected by the user (step S902). If it is determined in the step S902 that poster print configuration has not been selected (NO to the step S902), the present process is immediately terminated.

On the other hand, if poster print configuration has been selected (YES to the step S902), the CPU 105 checks a list of candidates each of which can be set as a poster print setting in the MFP 200 (step S903).

Then, the CPU 105 determines whether or not print-related configurations other than the print poster configuration has been made (step S904). If it is determined in the step S904 that print-related configurations other than the print poster configuration has been made (YES to the step S904), the CPU 105 selects values set in the configurations as respective settings (step S905), and then the CPU 105 proceeds to a step S907.

On the other hand, if no print-related configurations other than the print poster configuration has been made (NO to the step S904), the CPU 105 selects default values of the print-related configurations as respective settings (step S906).

Then, according to the settings selected in the step S905 or S906, the CPU 105 displays an at-a-glance collection of actual-size preview images in association with respective candidates each of which can be set as the poster print setting, which are in the list checked in the step S903 (step S907). The CPU 105 determines whether or not a poster print setting has been selected from the candidates displayed for actual-size preview (step S908). If it is determined in the step S908 that no poster print setting has been selected (NO to the step S908), the present process is immediately terminated.

On the other hand, if a poster print setting has been selected (YES to the step S908), the CPU 105 stores the selected poster print setting in the RAM 106 (step S909), followed by terminating the present process.

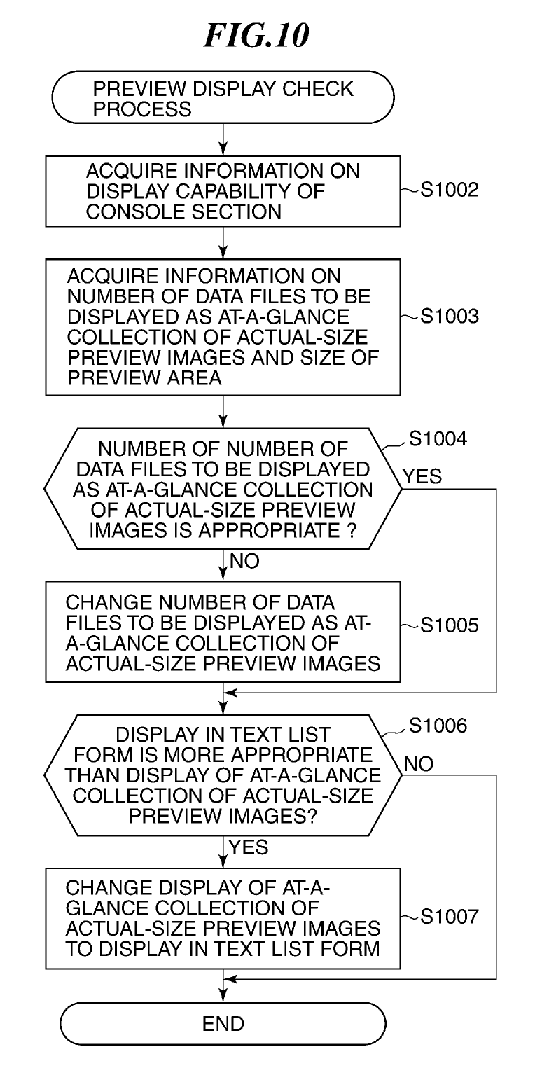

According to a process in FIG. 10, it is possible to further display actual-size preview images in association with the candidates each of which can be set as the poster print setting, respectively.

FIG. 10 is a flowchart of a preview display check process executed by the CPU 105 appearing in FIG. 1.

The preview display check process in FIG. 10 may be executed before execution of the step S507 in FIG. 5A or the step S515 in FIG. 5B.

Referring to FIG. 10, the CPU 105 acquires information on the display capability of the console section 110 for actual-size preview (step S1002). The display capability includes a displayable area size and a resolution. Then, the CPU 105 acquires information on the number of data files to be displayed as an at-a-glance collection of actual-size preview images, examples of which are indicated by 603 and 605 in FIG. 6, and a preview area size (step S1003).

Then, based on the information acquired in the steps S1002 and S1003, the CPU 105 determines whether or not the number of data files to be displayed as an at-a-glance collection of actual-size preview images is appropriate when taking into account the display capability of the console section 110 (step S1004).

If it is determined in the step S1004 that the number of data files to be displayed as an at-a-glance collection of actual-size preview images is appropriate (YES to the step S1004), the CPU 105 proceeds to a step S1006.

On the other hand, if the number of data files to be displayed as an at-a-glance collection of actual-size preview images is not appropriate (NO to the step S1004), the CPU 105 changes the number of data files to be displayed as an at-a-glance collection of actual-size preview images to an appropriate number (step S1005). Note that a value corresponding to the appropriate number, which is used to determine whether or not the number of data files to be displayed is appropriate, is stored in advance in the MFP 200.

Then, the CPU 105 determines whether or not the display in text list form is more appropriate than the display of an at-a-glance collection of actual-size preview images, when taking into account the display capability of the console section 110 (step S1006).

If it is determined in the step S1006 that the display in text list form is not more appropriate than the display of an at-a-glance collection of actual-size preview images (NO to the step S1006), the present process is immediately terminated.

On the other hand, if it is determined in the step S1006 that the display in text list form is more appropriate than the display of an at-a-glance collection of actual-size preview images (YES to the step S1006), the CPU 105 changes the display of an at-a-glance collection of actual-size preview images to the display in text list form (step S1007), followed by terminating the present process.

According to the process in FIG. 10, in actual-size preview, it is possible to change the number of actual-size preview images to be displayed, according to the display size of the console section 110. Further, it is possible to change the display of an at-a-glance collection of actual-size preview images to the display in text list form depending on the display capability of the console section 110. Note that the display in text list form may be provided such that each data file in text display form is associated with a preview image thereof to thereby enable the preview image to be displayed by selecting the data file.

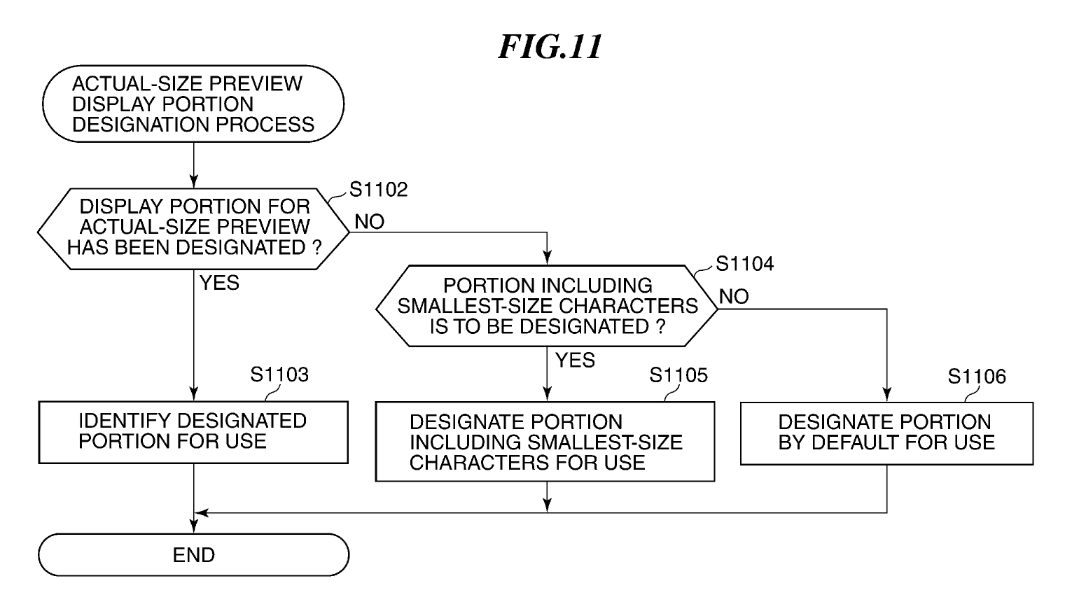

FIG. 11 is a flowchart of an actual-size preview display portion designation process executed by the CPU 105 appearing in FIG. 1.

The actual-size preview display portion designation process in FIG. 11 may be executed before execution of the step S507 in FIG. 5A or the step S515 in FIG. 5B.

Referring to FIG. 11, the CPU 105 determines whether or not a display portion for actual-size preview has been designated by the user (step S1102). If it is determined in the step S1102 that a display portion for actual-size preview has been designated (YES to the step S1102), the CPU 105 identifies the designated portion of an associated image (step S1103) for actual-size preview such that the designated portion is used for at-a-glance collection display, followed by terminating the present process.

On the other hand, if no display portion for actual-size preview has been designated (NO to the step S1102), the CPU 105 determines whether or not to designate an image portion including smallest-size characters (step S1104).

If it is determined in the step S1104 that an image portion including smallest-size characters is to be designated (YES to the step S1104), the CPU 105 designates the image portion including smallest-size characters for actual-size preview such that the designated portion is used for at-a-glance collection display (step S1105), followed by terminating the present process.

On the other hand, if an image portion including smallest-size characters is not to be designated (NO to the step S1104), the CPU 105 designates an image portion by default for actual-size preview such that the designated portion is used for at-a-glance collection display (step S1106), followed by terminating the present process.

According to the process in FIG. 11, it is possible to display an actual-size preview image such that out of the image, a portion designated in advance or a portion including smallest-size characters can be viewed.

The present invention may be applied to a system comprising a plurality of apparatuses or to a single apparatus, such as a scanner, a printer, a PC, a copying machine, a multifunction peripheral, or a facsimile machine.

Although in the above-described embodiment, a control unit provided together with a printing apparatus constitutes an image forming apparatus as a single apparatus, this is not limitative, but insofar as the control unit is equipped with the functions of the above-described embodiment and is capable of controlling the printing apparatus, it can also include an apparatus, such as a PC or a portable terminal apparatus. In this case, the control unit is provided as an apparatus separate from the printing apparatus and communicably connected to the printing apparatus via a wireless communication network, such as a wireless LAN, or a wired communication network implemented e.g. by the Ethernet.

Aspects of the present invention can also be realized by a computer of a system or apparatus (or devices such as a CPU or MPU) that reads out and executes a program recorded on a memory device to perform the functions of the above-described embodiment, and by a method, the steps of which are performed by a computer of a system or apparatus by, for example, reading out and executing a program recorded on a memory device to perform the functions of the above-described embodiment. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims priority from Japanese Patent Application No. 2011-196150 filed Sep. 8, 2011, which is hereby incorporated by reference herein in its entirety.

What is claimed is:

1. An image forming apparatus comprising:
a forming unit configured to form an image on a recording medium;
a display unit configured to display information;
a first setting unit configured to set a size of a recording medium on which an image is to be formed;
a second setting unit configured to set aggregation printing in which images of a plurality of pages are printed in an aggregated manner such that the images are formed on one page of the recording medium;
a first actual-size preview unit configured to be operable when the size of the recording medium is to be set by said first setting unit, to cause said display unit to display an image in the same size as a size of the image assumed when formed on the recording medium, in association with each of sizes of the recording medium which can be set for image formation by the image forming apparatus; and
a second actual-size preview unit configured to be operable when the aggregation printing is to be set by said second setting unit, to cause said display unit to display an image in the same size as a size of the image assumed when formed on the recording medium, in association with each of numbers of pages which can be set for the aggregation printing by the image forming apparatus.

2. The image forming apparatus according to claim 1, wherein said first actual-size preview unit causes said display unit to display images according to a setting of the aggregation printing set by said second setting unit, and said second actual-size preview unit causes said display unit to display images according to a size of the recording medium set by said first setting unit.

3. The image forming apparatus according to claim 1, wherein when the sizes of the recording medium which can be set for image formation include a size of a type of the recording medium on which image formation cannot be performed by the image forming apparatus due to absence of the type of the recording medium, information indicative of existence of the size of the type of the recording medium on which image formation cannot be performed is displayed on said display unit, or said first actual-size preview unit and said second actual-size preview unit cause said display unit to display an actual-size preview image associated with the size of the type of the recording medium on which image formation cannot be performed in a grayed-out manner or not to display the actual-size preview image.

4. The image forming apparatus according to claim 1, wherein said first actual-size preview unit and said second actual-size preview unit cause said display unit to further display an actual-size preview image, in association with each of executable settings of poster printing.

5. The image forming apparatus according to claim 1, wherein said first actual-size preview unit and said second actual-size preview unit change the number of actual-size preview images to be displayed, according to a display size of said display unit.

6. The image forming apparatus according to claim 1, further including a display form changing unit configured to change display of actual-size preview images to text list display, depending on a display size of said display unit.

7. The image forming apparatus according to claim 1, wherein said first actual-size preview unit and said second actual-size preview unit cause said display unit to display an actual-size preview image such that an image portion designated in advance can be viewed or such that smallest ones of characters included in the image can be viewed.

8. An image forming apparatus comprising:
a forming unit configured to form an image on a recording medium;
a display unit configured to display information;
a first setting unit configured to set a size of a recording medium on which an image is to be formed; and
an actual-size preview unit configured to be operable when the size of the recording medium is to be set by said first setting unit, to cause said display unit to display an image in the same size as a size of the image assumed when formed on the recording medium, in association with each of sizes of the recording medium which can be set for image formation by the image forming apparatus.

9. The image forming apparatus according to claim 8, further comprising a second setting unit configured to set aggregation printing in which images of a plurality of pages are printed in an aggregated manner such that the images are formed on one page of the recording medium, and
wherein said actual-size preview unit causes said display unit to display images according to a setting of the aggregation printing set by said second setting unit.

10. A controller comprising:
a print control unit configured to cause an image to be printed on a sheet;
a display unit configured to display information;
a first setting unit configured to set a sheet size of a sheet to be used for printing;
a second setting unit configured to set aggregation printing in which images of a plurality of pages are printed in an aggregated manner such that the images are printed on one page of the sheet;
a first actual-size preview unit configured to be operable when the size of the sheet is to be set by said first setting unit, to cause said display unit to display an image in the same size as a size of the image assumed when printed on the sheet, in association with each of sizes of the sheet which can be used in an image forming apparatus; and
a second actual-size preview unit configured to be operable when the aggregation printing is to be set by said second setting unit, to cause said display unit to display an image in the same size as a size of the image assumed when printed on the sheet, in association with each of numbers of pages which can be set for the aggregation printing by the image forming apparatus.

11. A controller comprising:
a print control unit configured to cause an image to be printed on a sheet;
a display unit configured to display information;
a first setting unit configured to set a sheet size of a sheet to be used for printing; and
an actual-size preview unit configured to be operable when a sheet size is to be set by said first setting unit, to cause said display unit to display an image in the same size as a size of the image assumed when printed on the sheet, in association with each of sizes of the sheet which can be used in an image forming apparatus.

12. A method of controlling an image forming apparatus including a forming unit configured to form an image on a recording medium, and a display unit configured to display information, comprising:
setting a size of a recording medium on which an image is to be formed;
setting aggregation printing in which images of a plurality of pages are printed in an aggregated manner such that the images are formed on one page of the recording medium;
causing, when the size of the recording medium is to be set, the display unit to display an image in the same size as a size of the image assumed when formed on the recording medium, in association with each of sizes of the recording medium which can be set for image formation by the image forming apparatus; and
causing, when the aggregation printing is to be set, the display unit to display an image in the same size as a size of the image assumed when formed on the recording medium, in association with each of numbers of pages which can be set for the aggregation printing by the image forming apparatus.

13. A method of controlling an image forming apparatus including a forming unit configured to form an image on a recording medium, and a display unit configured to display information, comprising:
setting a size of a recording medium on which an image is to be formed; and
causing, when the size of the recording medium is to be set, the display unit to display an image in the same size as a size of the image assumed when formed on the recording medium, in association with each of sizes of the recording medium which can be set for image formation by the image forming apparatus.

14. A method of controlling a controller including a print control unit configured to cause an image to be printed on a sheet, and a display unit configured to display information, comprising:
setting a sheet size of a sheet to be used for printing;
setting aggregation printing in which images of a plurality of pages are printed in an aggregated manner such that the images are printed on one page of the sheet;
causing, when the size of the sheet is to be set, the display unit to display an image in the same size as a size of the image assumed when printed on the sheet, in association with each of sizes of the sheet which can be used in an image forming apparatus; and
causing, when the aggregation printing is to be set, the display unit to display an image in the same size as a size of the image assumed when printed on the sheet, in association with each of numbers of pages which can be set for the aggregation printing by the image forming apparatus.

15. A method of controlling a controller including a print control unit configured to cause an image to be printed on a sheet, and a display unit configured to display information, comprising:
setting a sheet size of a sheet to be used for printing; and
causing, when a sheet size is to be set, the display unit to display an image in the same size as a size of the image assumed when printed on the sheet, in association with each of sizes of the sheet which can be used in an image forming apparatus.

16. A non-transitory computer-readable storage medium storing a computer-executable program for causing a computer to execute a method of controlling an image forming apparatus including a forming unit configured to form an image on a recording medium, and a display unit configured to display information,
wherein the method comprises:
setting a size of a recording medium on which an image is to be formed;
setting aggregation printing in which images of a plurality of pages are printed in an aggregated manner such that the images are formed on one page of the recording medium;
causing, when the size of the recording medium is to be set, the display unit to display an image in the same size as a size of the image assumed when formed on the recording medium, in association with each of sizes of the recording medium which can be set for image formation by the image forming apparatus; and
causing, when the aggregation printing is to be set, the display unit to display an image in the same size as a size of the image assumed when formed on the recording medium, in association with each of numbers of pages which can be set for the aggregation printing by the image forming apparatus.

17. A non-transitory computer-readable storage medium storing a computer-executable program for causing a computer to execute a method of controlling an image forming apparatus including a forming unit configured to form an image on a recording medium, and a display unit configured to display information,
wherein the method comprises:
setting a size of a recording medium on which an image is to be formed; and
causing, when the size of the recording medium is to be set, the display unit to display an image in the same size as a size of the image assumed when formed on the recording medium, in association with each of sizes of the recording medium which can be set for image formation by the image forming apparatus.

18. A non-transitory computer-readable storage medium storing a computer-executable program for causing a computer to execute a method of controlling a controller including a print control unit configured to cause an image to be printed on a sheet, and a display unit configured to display information,
wherein the method comprises:
setting a sheet size of a sheet to be used for printing;
setting aggregation printing in which images of a plurality of pages are printed in an aggregated manner such that the images are printed on one page of the sheet;
causing, when the size of the sheet is to be set, the display unit to display an image in the same size as a size of the image assumed when printed on the sheet, in association with each of sizes of the sheet which can be used in an image forming apparatus; and
causing, when the aggregation printing is to be set, the display unit to display an image in the same size as a size of the image assumed when printed on the sheet, in association with each of numbers of pages which can be set for the aggregation printing by the image forming apparatus.

19. A non-transitory computer-readable storage medium storing a computer-executable program for causing a computer to execute a method of controlling a controller including a print control unit configured to cause an image to be printed on a sheet, and a display unit configured to display information,
wherein the method comprises:
setting a sheet size of a sheet to be used for printing; and
causing, when a sheet size is to be set, the display unit to display an image in the same size as a size of the image assumed when printed on the sheet, in association with each of sizes of the sheet which can be used in an image forming apparatus.
